(19) United States
(12) Patent Application Publication
(10) Pub. No.: US 2024/0225112 A1
(43) Pub. Date: Jul. 11, 2024

(54) MULTI-LAYER SUSCEPTOR ARRANGEMENT FOR INDUCTIVELY HEATING AN AEROSOL-FORMING SUBSTRATE

(71) Applicant: Philip Morris Products S.A., Neuchatel (CH)

(72) Inventor: Andreas Michael ROSSOLL, Neuchatel (CH)

(73) Assignee: Philip Morris Products S.A., Neuchatel (CH)

(21) Appl. No.: 18/558,594

(22) PCT Filed: May 5, 2022
(86) PCT No.: PCT/EP2022/062080

§ 371 Date: Nov. 2, 2023

(30) Foreign Application Priority Data
May 6, 2021 (EP) 21172575.9

(51) Int. Cl. A24F 40/465; A24D 1/20

(52) U.S. Cl. CPC A24F 40/465; A24D 1/20

(57) ABSTRACT

A multi-layer susceptor arrangement for inductively heating an aerosol-forming substrate, the multi-layer susceptor arrangement including: a first layer including a first susceptor material; and a second layer including a second susceptor material, the second susceptor material including a Ni—Fe-alloy including one of: 79 wt %-82 wt % Ni and 13 wt %-15 wt % Fe, or 79 wt %-82 wt % Ni, 4 wt %-6 wt % Mo, less than 1 wt % of Si and Mn combined together, and 13 wt %-15 wt % Fe, or 77 wt % Ni, 16 wt % Fe, 5 wt % Cu, and 2 wt % of one of Cr and Mo, or 77 wt % Ni, 14 to 15 wt % Fe, 4 wt % Cu, and 4 wt % of Mo.

The present invention relates to a multi-layer susceptor arrangement for inductively heating an aerosol-forming substrate as well as to an inductively heatable aerosol-generating article comprising an aerosol-forming substrate and such a multi-layer susceptor arrangement for heating the substrate. The invention further relates to an aerosol-generating system comprising such an aerosol-generating article and an inductively heating aerosol-generating device for use with the article.

Generating aerosols by inductively heating aerosol-forming substrates which are capable to form an inhalable aerosol upon heating is generally known from prior art. For heating the substrate, the substrate may be part of an aerosol-generating article that is received within an aerosol-generating device. The device may comprise an induction source for generating an alternating magnetic field used to inductively heat a susceptor arrangement by inducing at least one of eddy currents and hysteresis losses in the susceptor material. The susceptor arrangement may be integral part of the article and arranged such as to be in thermal proximity or direct physical contact with the substrate to be heated.

For controlling the temperature of the substrate, multi-layer susceptor arrangements have been proposed which comprise at least a first layer and a second layer firmly bound together. While the first layer comprises a first susceptor material being optimized with regard to heat loss and thus heating efficiency, the second layer comprises a second susceptor material being used as temperature marker. For this, the second susceptor material is a magnetic (ferro- or ferrimagnetic) and chosen such as to have a Curie temperature corresponding to a predefined temperature point for heating the substrate. At its Curie temperature, the magnetic permeability of the second susceptor material drops to unity leading to a change of its magnetic properties from ferro- or ferrimagnetic to paramagnetic. The change of the magnetic properties is accompanied by a temporary change of the electrical resistance of the susceptor arrangement. Thus, by monitoring a corresponding change of the electrical current through the induction source it can be detected when the second susceptor material has reached its Curie temperature and, thus, when the predefined temperature point has been reached.

The desired properties of the susceptor materials are typically chosen with regard to the individual materials in a non-assembled situation. However, when assembling the first and second susceptor materials to each other to form a multi-layer susceptor arrangement, it has been observed that the specific properties of the layers, in particular the magnetic properties, may change as compared to the non-assembled state. In many cases, joining the layers and further processing the susceptor arrangement may even impair the originally desired properties and effects of the layer materials.

Therefore, it would be desirable to have a multi-layer susceptor arrangement for inductively heating an aerosol-forming substrate with the advantages of prior art solutions, whilst mitigating their limitations. In particular, it would be desirable to have a multi-layer susceptor arrangement with no or only little variation of its magnetic properties after processing and during subsequent operation.

According to the invention there is provided a multi-layer susceptor arrangement for inductively heating an aerosol-forming substrate. The susceptor arrangement comprises at least a first layer comprising a first susceptor material and a second layer comprising a second susceptor material. The second susceptor material comprises or consists of an Ni—Fe-alloy comprising 75 wt %-85 wt % Ni and 10 wt %-25 wt % Fe.

According to the invention it has been found that the variations of the magnetic properties observed with the multi-layer susceptor arrangements known from prior art are caused by a combination of magnetostriction properties and internal mechanical stress being present in the susceptor arrangement after its processing and throughout its temperature range of operation. In particular, it has been found that the specific nature of such multi-layer susceptor arrangements, in particular different coefficients of thermal expansion between the various layers, may result in thermal stress. For example, processing of a multi-layer susceptor arrangement may comprise intimately connecting the various layer materials to each other at a given temperature, followed by a heat treatment of the assembled susceptor arrangement, such as annealing. During a subsequent cooldown of the susceptor arrangement, the individual layers want to contract according to their specific coefficients of thermal expansion which may differ from each other. However, given the fact that the layers are firmly bond to each other, they cannot contract freely, that is, independently from each other. Inevitably, this results in internal mechanical stress and thermal deformations of the susceptor arrangement. The mechanical stress in turn has an impact on the magnetic properties of the magnetic layers, since most ferro- or ferrimagnetic materials are subject to magnetostriction. That is, when being exposed to a magnetic field, these materials may either expand or contract. Vice versa, when free thermal expansion or contraction is restricted, the magnetization of such materials is altered, that is, either enhanced or decreased. This applies in particular for the magnetic susceptor material of the second susceptor layer being used as a temperature marker.

In fact, the impact of the restricted free movement between the various susceptor layers on the magnetostriction is difficult to control during the mass production of such susceptor arrangements. In particular, these undesired effects may vary across different locations of the precursor laminate material which a plurality of multi-layer susceptor arrangements are finally made of. As a result, the magnetic properties may vary between different susceptor arrangements even though being made of the same precursor material.

In order to reduce these undesired effects, the susceptor arrangement according to the present invention includes a second susceptor material which comprises or consists of an Ni—Fe-alloy having 75 wt %-85 wt % Ni and 10 wt %-25 wt % Fe. More particular, the Ni—Fe-alloy may comprise 79 wt %-82 wt % Ni and 13 wt %-15 wt % Fe. Advantageously, it has been found that Ni—Fe-alloys including Ni and Fe in the above ranges exhibit only weak or even no magnetostriction. As a consequence, the second susceptor material of the functional second layer experiences no or only at least a reduced modification of its magnetic properties after its processing and throughout its temperature range of operation. This in turn allows for a mass production of multi-layer susceptor arrangements having a functional magnetic layer with no or only little variation of its magnetic properties after processing and during subsequent operation.

As used herein, processing of the multi-layer susceptor arrangement may comprise at least one of intimately coupling the layer materials to each other at a given temperature, or a heat treatment of the multi-layer susceptor arrangement, such as annealing. In particular, the susceptor arrangement may be a heat treated susceptor arrangement. In any cases, during a processing as referred to herein the temperature of the layers or the assembly, respectively, is different from the operating temperature of the susceptor arrangement when being used for inductively heating the aerosol-forming substrate. Typically, the temperatures during intimately connecting the layer materials to each other or during a heat treatment of the multi-layer susceptor arrangement are larger than the operating temperatures of the susceptor arrangement during the inductive heating of the aerosol-forming substrate.

As used herein, the unit “wt %” stands for “weight percent” or “percentage by weight”. That is, it denotes the mass fraction of an element within the alloy which is the ratio of the mass of that respective element to the total mass of a sample of that alloy.

In addition to the main components, the remainder of the Ni—Fe-alloy may comprise one or more of the following elements: Co, Cr, Cu, Mn, Mo, Nb, Si, Ti and V.

As used herein, the symbol Ni stands for the chemical element nickel, the symbol Fe stands for the chemical element iron, the symbol Co stands for the chemical element cobalt, the symbol Cr stands for the chemical element chromium, the symbol Cu stands for the chemical element copper, the symbol Mn stands for the chemical element manganese, the symbol Mo stands for the chemical element molybdenum, the symbol Nb stands for the chemical element niobium, the symbol Si stands for the chemical element silicon, the symbol Ti stands for the chemical element titanium, and the symbol V stands for the chemical element vanadium.

According to one example, the Ni—Fe-alloy may comprise 79 wt %-82 wt % Ni, 4 wt %-6 wt % Mo, less than 1 wt % of Si and Mn combined together, and 13 wt %-15 wt % Fe. As used herein, “1 wt % of Si and Mn combined together” means “Si and Mn below 1 wt % in sum”.

According to another example, the Ni—Fe-alloy may comprise 77 wt % Ni, 16 wt % Fe, 5 wt % Cu, and 2 wt % of one of Cr and Mo.

According to yet another example, the Fe—Ni alloy may comprise 77 wt % Ni, 4 wt % Mo, 4 wt % Cu and 14 wt %-15 wt % Fe.

Advantageously, these specific examples of the Ni—Fe-alloy exhibit particularly weak magnetostriction.

According to yet another example, the Ni—Fe-alloy may be ASTM A 753 alloy of type 3, (similar to UNS number: N14076) having 75 wt %-78 wt % Ni and 10 wt %-19 wt % Fe. The remainder may be constituted by one or more of the following elements: Co, Cr, Cu, Mn, Mo, and Si.

According to still another example, the Ni—Fe-alloy may be ASTM A 753 alloy of type 4, (similar to UNS number: N14080 and to EN numeric designation: 2.4545) having 77 wt %-82 wt % Ni and 10 wt %-17.5 wt % Fe (or even 9.5 wt %-17.5 wt % Fe). The remainder may be constituted by one or more of the following elements: Co, Cr, Cu, Mn, Mo, and Si.

As mentioned above, the second susceptor material preferably is configured for monitoring a temperature of the susceptor arrangement, that is, as a temperature marker. For this, the second susceptor material may be selected to have a Curie temperature which essentially corresponds to a predefined temperature point of the heating process. In particular, the second susceptor material may be selected to have a Curie temperature which essentially corresponds to a predefined maximum heating temperature of the susceptor arrangement. The maximum desired heating temperature may be defined to be approximately the temperature that the susceptor arrangement should be heated to in order to generate an aerosol from the aerosol-forming substrate. However, the maximum desired heating temperature should be low enough to avoid local overheating or even burning of the aerosol-forming substrate. Preferably, the Curie temperature of the second susceptor material should be below an ignition point of the aerosol-forming substrate. The second susceptor material may have a Curie temperature below 500° C., preferably equal to or below 400° C., in particular equal to or below 390° C. For example, the second susceptor may have a Curie temperature between 150° C. and 400° C., in particular between 200° C. and 400° C. Even though the second layer primarily is a functional layer providing a temperature marker by the Curie temperature of the second susceptor material, it may also contribute to the inductive heating of the susceptor arrangement.

Yet, it is preferably the first layer including the first susceptor material which is configured for heating the aerosol-forming substrate primarily. For this, the first susceptor material may be optimized with regard to heat loss and thus heating efficiency.

As used herein, the term “susceptor material” refers to a material that is capable to convert electromagnetic energy into heat when subjected to an alternating field. This may be the result of at least one hysteresis losses and eddy currents induced in the susceptor material, depending on its electrical and magnetic properties. Hysteresis losses occur in ferromagnetic or ferrimagnetic susceptor materials due to magnetic domains within the material being switched under the influence of an alternating electromagnetic field. Eddy currents may be induced, if the susceptor material is electrically conductive. In case of an electrically conductive ferromagnetic susceptor or an electrically conductive ferrimagnetic susceptor, heat can be generated due to both, eddy currents and hysteresis losses.

Accordingly, the first susceptor material may be at least one of electrically conductive or magnetic, that is, either ferromagnetic or ferrimagnetic. If the first susceptor material is electrically conductive, it may also be paramagnetic. In case the first susceptor material is magnetic (ferromagnetic or ferrimagnetic), it is preferably chosen such as to have a Curie temperature that is distinct from, in particular higher than the Curie temperature of the second susceptor material. In this specific configuration, the first susceptor material may have a first Curie temperature and the second susceptor material may have a second Curie temperature.

Preferably, the first susceptor material is made of an anti-corrosive material. Thus, the first susceptor material is advantageously resistant to any corrosive influences. This is of particular interest in case the susceptor arrangement is embedded in an aerosol-generating article in direct physical contact with aerosol-forming substrate.

Preferably, the first susceptor material comprises a metal, for example ferritic iron, or stainless steel, in particular ferromagnetic stainless steel, for example ferritic stainless steel. It may be particularly preferred that the first susceptor material comprises a 400 series stainless steel such as grade 410 stainless steel, or grade 420 stainless steel, or grade 430 stainless steel, or stainless steel of similar grades.

The first susceptor material may alternatively comprise a suitable non-magnetic, in particular paramagnetic, conductive material, such as aluminum (AI). In a paramagnetic conductive material inductive heating occurs solely by resistive heating due to eddy currents.

Alternatively, the first susceptor material may comprise a non-conductive ferrimagnetic material, such as a non-conductive ferrimagnetic ceramic. In that case, heat is only by generated by hysteresis losses.

The second layer may be intimately coupled to the first layer. As used herein, the term “intimately coupled” refers to a mechanical coupling between two layers within the multi-layer susceptor arrangement such that a mechanical force may be transmitted between the two layers, in particular in a direction parallel to the layer structure. The coupling may be a laminar, two-dimensional, areal or full-area coupling, that is, a coupling across the respective opposing surfaces of the two layers. The coupling may be direct. In particular, the two layers, which are intimately coupled with each other, may be in direct contact with each other. Alternatively, the coupling may be indirect. In particular, the two layers may be indirectly coupled via at least one intermediate layer. Preferably, the second layer is arranged upon and intimately coupled to, in particular directly connected with the first layer.

The multi-layer susceptor arrangement may further comprise a third layer. The third layer may be intimately coupled to the second layer. In this context, the term “intimately coupled” is used in the same way as defined above with regard to the first and second layer.

Preferably, the third layer is a protective layer configured to at least one of: to avoid aerosol-forming substrate sticking to the surface of the susceptor arrangement, to avoid material diffusion, for example metal migration, from the susceptor materials into the aerosol-forming substrate, to avoid or reduce thermal bending due to differences in thermal dilatation between the layers, or to protect other layers, in particular the second layer from any corrosive influences.

The latter is particularly important, where the susceptor arrangement is embedded in an aerosol-forming substrate of an aerosol-generating article, that is, where the susceptor arrangement is in direct physical contact with aerosol-forming substrate. For this, the third layer preferably comprises or consists of an anti-corrosive material. Advantageously, the anti-corrosive material improves the aging characteristics of those portions of the outer surface of the non-corrosion resistant second layer which are covered by the third layer and thus not directly exposed to the environment.

As used herein, the term “third layer” refers to a layer in addition to the first and second layer that is different from the first and second layer. In particular, any possible oxide layer on a surface of the first or second layer resulting from oxidation of the first or second susceptor material is not to be considered a third layer, in particular not a third layer comprising or consisting of an anti-corrosive material.

The third layer may comprise or consist of a material identical to the first susceptor material of the first layer. Due to this, the multi-layer susceptor arrangement comprises at least two layers having the same coefficient of thermal expansion which results in reduced deformations of the susceptor arrangement through the temperature range of operation. This applies in particular where the susceptor arrangement only comprises the first, second and third layer and where the second layer is symmetrically sandwiched between the first and third layer.

Accordingly, the third layer may comprise a metal, for example ferritic iron, or stainless steel, for example ferritic stainless steel, in particular a 400 series stainless steel such as grade 410 stainless steel, or grade 420 stainless steel, or grade 430 stainless steel, or stainless steel of similar grades. Alternatively, the third layer may comprise a suitable non-magnetic, in particular paramagnetic, conductive material, such as aluminum (AI). Likewise, the third layer may comprise a non-conductive ferrimagnetic material, such as a non-conductive ferrimagnetic ceramic.

It is also possible that the third layer comprises or consists of an austenitic stainless steel. Advantageously, due to its paramagnetic characteristics and high electrical resistance, austenitic stainless steel only weakly shields the second layer from the magnetic field to be applied to the first and second susceptor material. As an example, the third layer may comprise or consist of X5CrNi18-10 (according to EN (European Standards) nomenclature, material number 1.4301, also known as V2A steel) or X2CrNiMo17-12-2 (according to EN (European Standards) nomenclature, material number 1.4571 or 1.4404, also known as V4A steel). In particular, the third layer may comprise or consist of one of 301 stainless steel, 304 stainless steel, 304L stainless steel, 316 stainless steel or 316L stainless steel (nomenclature according to SAE steel grades [Society of Automotive Engineers]).

In general, the various layers of the multi-layer susceptor arrangement may have either the same layer thickness or different layer thicknesses. As used herein, the term “thickness” refers to any dimensions extending between the top and the bottom side, for example between a top side and a bottom side of a layer or a top side and a bottom side of the multi-layer susceptor arrangement. Likewise, the term “width” is used herein to refer to any dimensions extending between two opposed lateral sides of a layer or the susceptor arrangement. The term “length” is used herein to refer to any dimensions extending between the front and the back or between other two opposed sides orthogonal to the two opposed lateral sides forming the width. Preferably, a width extension is larger than a thickness extension. Likewise, a width extension may be smaller than a length extension. Thickness, width and length may be orthogonal to each other.

The first layer may have a layer thickness in range between 20 micrometer and 60 micrometer, in particular between 30 micrometer and 50 micrometer, preferably 40 micrometer.

The second layer may have a layer thickness in range between 4 micrometer and 20 micrometer, in particular between 8 micrometer and 16 micrometer, preferably between 10 micrometer and 15 micrometer.

The third layer—if present—may have a layer thickness in range between 2 micrometer and 6 micrometer, in particular between 3 micrometer and 5 micrometer, preferably between 3 micrometer and 4 micrometer.

The layer thickness of the third layer may be in a range of 0.05 to 1.5, in particular 0.1 to 1.25, or 0.95 to 1.05, in particular 1 times a layer thickness of the first layer, or the layer thickness of the third layer may be in a range of 0.02 to 0.2, in particular 0.03 to 0.2 or 0.03 to 0.1, times a layer thickness of the first layer.

In case of a symmetric or close-to-symmetric layer configuration, the first layer as well as the third layer may have a thickness in range between 2 micrometer and 20 micrometer, in particular between 3 micrometer and 10 micrometer, preferably 3 to 6 micrometer.

The second layer may then have a thickness in range between 5 and 50 micrometer, in particular between 10 and 40 micrometer, preferably 20 to 40 micrometer.

In general, the multi-layer susceptor arrangement described herein may be used to realize different geometrical configurations of the susceptor arrangement.

Preferably, the multi-layer susceptor arrangement may be an elongate, in particular strip-like, susceptor arrangement. The elongate susceptor arrangement may have a thickness in a range of 0.03 millimeter to 0.15 millimeter, more preferably 0.05 millimeter to 0.09 millimeter. The elongate susceptor arrangement may have a width in a range of 2 millimeter to 6 millimeter, in particular 4 millimeter to 5 millimeter. Likewise, the elongate susceptor arrangement may have length in range of 8 millimeter to 19 millimeter, in particular 10 millimeter to 14 millimeter, preferably 10 to 12 millimeter.

Alternatively, the multi-layer susceptor arrangement may be a multi-layer susceptor rod or a multi-layer susceptor pin or a multi-layer susceptor sleeve or a multi-layer susceptor cup or a cylindrical multi-layer susceptor.

As used herein, the terms “first layer”, “second layer” and “third layer” are only nominal without necessarily specifying a particular order or sequence of the respective layers. Preferably, the first layer, the second layer and the third layer are adjacent layers of the multi-layer susceptor arrangement. In this case, the first layer, the second layer and the third layer may be in direct intimate physical contact with each other. In particular, the second layer may be sandwiched between the first layer and the third layer. More particularly, the third layer may be arranged upon and intimately coupled to the second layer. The second layer in turn may be arranged upon and intimately coupled to the first layer. At least one of the first layer or the third layer may be an edge layer of the multi-layer susceptor arrangement.

With regard to the processing of the susceptor arrangement, in particular with regard to assembly of the various layers, each of the layers may be plated, deposited, coated, cladded or welded onto a respective adjacent layer. In particular, any of these layers may be applied onto a respective adjacent layer by spraying, dip coating, roll coating, electroplating or cladding. This holds in particular for the first layer, the second layer and the third layer and—if present—the at least one intermediate layer. Either way, any of the configurations or layer structures described above falls within the term “intimately coupled” as used herein and defined further above.

According to the invention there is also provided an inductively heatable aerosol-generating article comprising an aerosol-forming substrate and a multi-layer susceptor arrangement according to the present invention and as described herein that is configured and arranged to inductively heat the substrate.

As used herein, the term “aerosol-generating article” refers to an article comprising at least one aerosol-forming substrate capable of releasing volatile compounds when heated which can form an aerosol. Preferably, the aerosol-generating article is a heated aerosol-generating article. That is, an aerosol-generating article which comprises at least one aerosol-forming substrate that is intended to be heated rather than combusted. The aerosol-generating article may be a consumable, in particular a consumable to be discarded after a single use. For example, the article may be a cartridge including a liquid aerosol-forming substrate to be heated. As another example, the article may be a rod-shaped article, in particular a tobacco article, resembling conventional cigarettes.

As used herein, the term “aerosol-forming substrate” denotes a substrate formed from or comprising an aerosol-forming material that is capable of releasing volatile compounds upon heating in order to generate an aerosol. Preferably, the aerosol-forming substrate is intended to be heated rather than combusted in order to release the aerosol-forming volatile compounds. The aerosol-forming substrate may be a solid aerosol-forming substrate, a liquid aerosol-forming substrate, gel-like aerosol-forming substrate, or any combination thereof. For example, the aerosol-forming substrate may comprise both solid and liquid components. The aerosol-forming substrate may comprise a tobacco-containing material containing volatile tobacco flavor compounds, which are released from the substrate upon heating. Alternatively or additionally, the aerosol-forming substrate may comprise a non-tobacco material. The aerosol-forming substrate may further comprise an aerosol former. Examples of suitable aerosol formers are glycerin and propylene glycol. The aerosol-forming substrate may also comprise other additives and ingredients, such as nicotine or flavourants. The aerosol-forming substrate may also be a paste-like material, a sachet of porous material comprising aerosol-forming substrate, or, for example, loose tobacco mixed with a gelling agent or sticky agent, which could include a common aerosol former such as glycerin, and which is compressed or molded into a plug.

Preferably, the article may be an elongate article or a rod-shaped article. The elongate or rod-shaped article may have a shape resembling the shape of conventional cigarettes.

The aerosol-generating article, in particular elongate or rod-shaped article, may have a circular or elliptical or oval or square or rectangular or triangular or a polygonal cross-section.

As an example, the aerosol-generating article may be a rod-shaped article. In particular a cylindrical article comprising one or more of the following elements: a distal front plug element, a substrate element, a first tube element, a second tube element, and a filter element.

The substrate element preferably comprises the at least one aerosol-forming substrate to be heated and the susceptor arrangement in thermal contact with or thermal proximity to the aerosol-forming substrate. The substrate element may have a length of 10 millimeter to 14 millimeter, for example, 12 millimeter.

The first tube element is more distal than the second tube element. Preferably, the first tube element is proximal of the substrate element, whereas the second tube element is proximal of the first tube element and distal of the filter element, that is, between the first tube element and the filter element. At least one of the first tube element and the second tube element may comprise a central air passage. A cross-section of the central air passage of the second tube element may be larger than a cross-section of the central air passage of the first tube element. Preferably, at least one of the first tube element and the second tube element may comprise a hollow cellulose acetate tube. At least one of the first tube element and the second tube element may have a length of 6 millimeter to 10 millimeter, for example, 8 millimeters.

The filter element preferably serves as a mouthpiece, or as part of a mouthpiece together with the second tube element. As used herein, the term “mouthpiece” refers to a portion of the article through which the aerosol exits the aerosol-generating article. The filter element may have a length of 10 millimeter to 14 millimeter, for example, 12 millimeter.

The distal front plug element may be used to cover and protect the distal front end of the substrate element. The distal front plug element may have a length of 3 millimeter to 6 millimeter, for example, 5 millimeter. The distal front plug element may be made of the same material as the filter element

All of the aforementioned elements may be sequentially arranged along a length axis of the article in the above described order, wherein the distal front plug element preferably is arranged at a distal end of the article and the filter element preferably is arranged at a proximal end of the article. Each of the aforementioned elements may be substantially cylindrical. In particular, all elements may have the same outer cross-sectional shape and/or dimensions.

In addition, the elements may be circumscribed by one or more outer wrappers such as to keep the elements together and to maintain the desired cross-sectional shape of the rod-shaped article. Preferably, the wrapper is made of paper. The wrapper may further comprise adhesive that adheres the overlapped free ends of the wrapper to each other. For example, the distal front plug element, the substrate element and the first tube element may be circumscribed by a first wrapper, and the second tube element and the filter element may be circumscribed by a second wrapper. The second wrapper may also circumscribe at least a portion of the first tube element (after being wrapped by the first wrapper) to connect the distal front plug element, the substrate element and the first tube element being circumscribed by a first wrapper to the second tube element and the filter element. The second wrapper may comprise perforations around its circumference.

Further features and advantages of the aerosol-generating article according to the invention have been described with regard to the multi-layer susceptor arrangement and thus equally apply.

According to the present invention, there is provided an aerosol-generating system comprising an inductively heatable aerosol-generating article according to the present invention as well as and an inductively heating aerosol-generating device for use with the aerosol-generating article.

As used herein, the term “aerosol-generating device” describes an electrically operated device for interaction with an aerosol-generating article according to the present invention in order to generate an aerosol by inductively heating the aerosol-forming substrate via the susceptor arrangement. Preferably, the aerosol-generating device is a puffing device for generating an aerosol that is directly inhalable by a user through the user's mouth. In particular, the aerosol-generating device is a hand-held aerosol-generating device.

The device may comprise a receiving cavity for removably receiving at least a portion of the aerosol-generating article.

The aerosol-generating device comprises an inductive heating arrangement configured and arranged to generate an alternating magnetic field in the receiving cavity in order to inductively heat the susceptor arrangement, when the article is received in the aerosol-generating device. For generating the alternating magnetic field, the inductive heating arrangement may comprise at least one induction coil surrounding at least a portion of the susceptor arrangement, when the article is received in the cavity of the device. The at least one induction coil may be a helical coil or flat planar coil, in particular a pancake coil or a curved planar coil.

The inductive heating arrangement may further comprise an alternating current (AC) generator. The AC generator may be powered by a power supply of the aerosol-generating device. The AC generator is operatively coupled to the at least one induction coil. In particular, the at least one induction coil may be integral part of the AC generator. The AC generator is configured to generate a high frequency oscillating current to be passed through the at least one induction coil for generating an alternating magnetic field. The AC current may be supplied to the at least one induction coil continuously following activation of the system or may be supplied intermittently, such as on a puff by puff basis. Preferably, the inductive heating arrangement comprises a DC/AC converter including an LC network, wherein the LC network comprises a series connection of a capacitor and the inductor. The DC/AC converter may be connected to a DC power supply.

The inductive heating arrangement preferably is configured to generate a high-frequency magnetic field. As referred to herein, the high-frequency magnetic field may be in the range between 500 kHz (kilo-Hertz) to 30 MHz (Mega-Hertz), in particular between 5 MHz (Mega-Hertz) to 15 MHz (Mega-Hertz), preferably between 5 MHz (Mega-Hertz) and 10 MHz (Mega-Hertz).

The aerosol-generating device may further comprise a controller configured to control operation of the heating process, preferably in a closed-loop configuration, in particular for controlling heating of the aerosol-forming liquid to a pre-determined operating temperature.

The controller may be or may be art of an overall controller of the aerosol-generating device. The controller may comprise a microprocessor, for example a programmable microprocessor, a microcontroller, or an application specific integrated chip (ASIC) or other electronic circuitry capable of providing control. The controller may comprise further electronic components, such as at least one DC/AC inverter and/or power amplifiers, for example a Class-C power amplifier or a Class-D power amplifier or Class-E power amplifier. In particular, the induction source may be part of the controller.

The aerosol-generating device may also comprise a power supply, in particular a DC power supply configured to provide a DC supply voltage and a DC supply current to the induction source. Preferably, the power supply is a battery such as a lithium iron phosphate battery. The power supply may be rechargeable. The power supply may have a capacity that allows for the storage of enough energy for one or more user experiences. For example, the power supply may have sufficient capacity to allow for the continuous generation of aerosol for a period of around six minutes or for a period that is a multiple of six minutes. In another example, the power supply may have sufficient capacity to allow for a predetermined number of puffs or discrete activations of the induction source.

Further features and advantages of the aerosol-generating system according to the invention have been described with regard to the susceptor arrangement and the aerosol-generating article and thus equally apply.

The invention is defined in the claims. However, below there is provided a non-exhaustive list of non-limiting examples. Any one or more of the features of these examples may be combined with any one or more features of another example, embodiment, or aspect described herein.

Example Ex1: A multi-layer susceptor arrangement for inductively heating an aerosol-forming substrate, the susceptor arrangement comprising at least:
a first layer comprising a first susceptor material;
a second layer comprising a second susceptor material, wherein the second susceptor material comprises or consists of an Ni—Fe-alloy comprising 75 wt %-85 wt % Ni and 10 wt %-25 wt % Fe.

Example Ex2: The multi-layer susceptor arrangement according to example Ex1, wherein the Ni—Fe-alloy further comprises one or more of the following elements: Co, Cr, Cu, Mn, Mo, Nb, Si, Ti and V.

Example Ex3: The multi-layer susceptor arrangement according to any one of the preceding examples, wherein the Ni—Fe-alloy comprises 79 wt %-82 wt % Ni and 13 wt %-15 wt % Fe.

Example Ex4: The multi-layer susceptor arrangement according to any one of the preceding examples, wherein the Ni—Fe-alloy comprises 79 wt %-82 wt % Ni, 4 wt %-6 wt % Mo, less than 1 wt % of Si and Mn combined together, and 13 wt %-15 wt % Fe.

Example Ex5: The multi-layer susceptor arrangement according to any one of example Ex1 or example Ex2, wherein the Ni—Fe-alloy comprises 77 wt % Ni, 16 wt % Fe, 5 wt % Cu, and 2 wt % of one of Cr and Mo.

Example Ex6: The multi-layer susceptor arrangement according to any one of example Ex1 or example Ex2, wherein the Ni—Fe-alloy comprises 77 wt % Ni, 14 to 15 wt % Fe, 4 wt % Cu, and 4 wt % of Mo.

Example Ex7: The multi-layer susceptor arrangement according to any one of the preceding examples, wherein the first susceptor material comprises a metal, for example ferritic iron, or stainless steel, in particular a grade 410, grade 420, or grade 430 stainless steel.

Example Ex8: The multi-layer susceptor arrangement according to any one of the preceding examples, wherein the second layer is intimately coupled to the first layer.

Example Ex9: The multi-layer susceptor arrangement according to any one of the preceding examples, wherein the first layer has a layer thickness in range between 20 micrometer and 60 micrometer, in particular between 30 micrometer and 50 micrometer, preferably 40 micrometer.

Example Ex10: The multi-layer susceptor arrangement according to any one of the preceding examples, wherein the second layer has a layer thickness in range between 4 micrometer and 20 micrometer, in particular between 8 micrometer and 16 micrometer, preferably between 10 micrometer and 15 micrometer.

Example Ex11: The multi-layer susceptor arrangement according to any one of the preceding examples, further comprising a third layer intimately coupled to the second layer.

Example Ex12: The multi-layer susceptor arrangement according to example Ex11, wherein the third layer comprises or consists of an anti-corrosive material.

Example Ex13: The multi-layer susceptor arrangement according to any one of example Ex11 or example Ex12, wherein the third layer comprises or consists of a material identical to the first susceptor material of the first layer.

Example Ex14: The multi-layer susceptor arrangement according to any one of examples Ex11 to Ex13, wherein the third layer comprises or consists of a metal, for example ferritic iron, or stainless steel, in particular a grade 410, grade 420, or grade 430 stainless steel.

Example Ex15: The multi-layer susceptor arrangement according to any one of examples Ex11 to Ex12, wherein the third layer comprises or consists of an austenitic stainless steel.

Example Ex16: The multi-layer susceptor arrangement according to example Ex15, wherein the third layer comprises or consists of X5CrNi18-10 or X2CrNiMo17-12-2.

Example Ex17: The multi-layer susceptor arrangement according to example Ex15, wherein the third layer comprises or consists of one of 301 stainless steel, 304 stainless steel, 304L stainless steel, 316 stainless steel or 316L stainless steel.

Example Ex18: The multi-layer susceptor arrangement according to any one of examples Ex11 to Ex17, wherein the layer thickness of the third layer is in a range of 0.05 to 1.5, in particular 0.1 to 1.25, or 0.95 to 1.05, in particular 1 times a layer thickness of the first layer,

Example Ex19: The multi-layer susceptor arrangement according to any one of examples Ex11 to Ex17, wherein the layer thickness of the third layer is equal to a layer thickness of the first layer.

Example Ex20: The multi-layer susceptor arrangement according to any one of examples Ex11 to Ex19, wherein the third layer has a layer thickness in range between 2 micrometer and 6 micrometer, in particular between 3 micrometer and 5 micrometer, preferably between 3 micrometer and 4 micrometer.

Example Ex21: The multi-layer susceptor arrangement according to any one of examples Ex11 to Ex20, wherein the first layer, the second layer and the third layer are adjacent layers of the multi-layer susceptor arrangement.

Example Ex22: An inductively heatable aerosol-generating article comprising an aerosol-forming substrate and a multi-layer susceptor arrangement according to any one of the preceding examples.

Example Ex23: The aerosol-generating article according to example Ex22, wherein the susceptor arrangement is located in the aerosol-forming substrate.

Example Ex24: An aerosol-generating system comprising an inductively heatable aerosol-generating article according to any one of example Ex22 or example Ex23, and an inductively heating aerosol-generating device for use with the aerosol-generating article.

Examples will now be further described with reference to the figures in which:

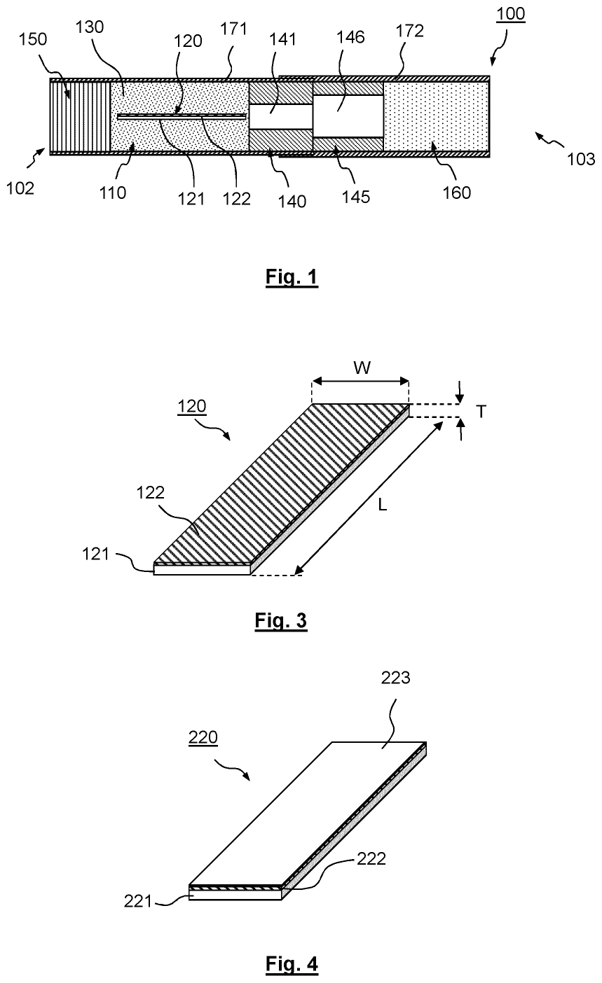

FIG. 1 schematically illustrates an exemplary embodiment of an inductively heatable aerosol-generating article comprising a multi-layer susceptor arrangement according to the present invention;

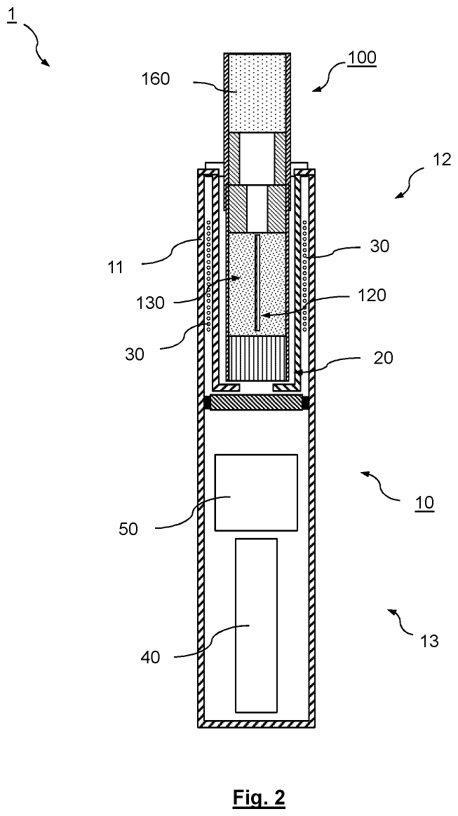

FIG. 2 schematically illustrates an exemplary embodiment of an aerosol-generating system comprising the aerosol-generating article according to FIG. 1;

FIG. 3 shows details of the multi-layer susceptor arrangement of the aerosol-generating article to FIG. 1; and

FIG. 4 shows details of another embodiment of the multi-layer susceptor arrangement according to the present invention.

FIG. 1 schematically illustrates an exemplary embodiment of an inductively heatable aerosol-generating article 100 according to the present invention (not to scale). The aerosol-generating article 100 is a substantially rod-shaped consumable comprising five elements sequentially arranged in coaxial alignment: a distal front plug element 150, a substrate element 110, a first tube element 140, a second tube element 145, and a filter element 160. The distal front plug element 150 is arranged at a distal end 102 of the article 100 to cover and protect the distal front end of the substrate element 110, whereas the filter element 160 is arranged at a proximal end 103 of the article 100. Both, the distal front plug element 150 and the filter element 160 may be made of the same filter material. The filter element 160 preferably serves as a mouthpiece, preferably as part of a mouthpiece together with the second tube element 145. The filter element may have a length of 10 millimeter to 14 millimeter, for example, 12 millimeter, whereas the distal front plug element 150 may have a length of 3 millimeter to 6 millimeter, for example, 5 millimeter. The substrate element 110 comprises an aerosol-forming substrate 130 to be heated as well as a multi-layer susceptor arrangement 120 according to a first embodiment of the present invention that is configured and arranged to heat the substrate 130. For this, the susceptor arrangement 120 is fully embedded in the substrate 130 such as to be in direct thermal contact with the substrate 130. The substrate element 110 may have a length of 10 millimeter to 14 millimeter, for example, 12 millimeter. Each one of the first and the second tube element 140, 145 is a hollow cellulose acetate tube having a central air passage 141, 146, wherein a cross-section of the central air passage 146 of the second tube element 145 is larger than a cross-section of the central air passage 141 of the first tube element 140. The first and second tube element 140, 145 may have a length of 6 millimeter to 10 millimeter, for example, 8 millimeters.

In use, an aerosol formed by volatile compounds released from the substrate element 110 is drawn through the first and second tube element 140, 145 and the filter element 160 towards the proximal end 103 of the article 100. Each of the aforementioned elements 150, 110,140, 145, 160 may be substantially cylindrical. In particular, all elements 150, 110,140, 145, 160 may have the same outer cross-sectional shape and dimensions.

In addition, the elements may be circumscribed by one or more outer wrappers such as to keep the elements together and to maintain the desired cross-sectional shape of the rod-shaped article. In the present embodiment, the distal front plug element 150, the substrate element 110 and the first tube element 140 are circumscribed by a first wrapper 140, whereas the second tube element 145 and the filter element 160 are circumscribed by a second wrapper 172. The second wrapper 172 also circumscribes at least a portion of the first tube element 140 (after being wrapped by the first wrapper 171) to connect the distal front plug element 150, the substrate element 110 and the first tube element 140 being circumscribed by the first wrapper 171 to the second tube element 145 and the filter element 160. Preferably, the first and the second wrapper 171, 172 are made of paper. In addition, the second wrapper 172 may comprise perforations around its circumference (not shown). The wrappers 171, 172 may further comprise adhesive that adheres the overlapped free ends of the wrappers to each other.

As illustrated in FIG. 2, the aerosol-generating article 100 is configured for use with an inductively heating aerosol-generating device 10. Together, the device 10 and the article 100 form an aerosol-generating system 1 according to the present invention. The aerosol-generating device 10 comprises a cylindrical receiving cavity 20 defined within a proximal portion 12 of the device 10 for receiving a least a distal portion of the article 100 therein. The device 10 further comprises an inductive heating arrangement including an induction coil 30 for generating an alternating, in particular high-frequency magnetic field within the cavity 20. In the present embodiment, the induction coil 30 is a helical coil circumferentially surrounding the cylindrical receiving cavity 20. The coil 30 is arranged such that the susceptor arrangement 120 of the aerosol-generating article 100 is exposed to magnetic field upon inserting the article 100 into the cavity 20 of the device 10. Thus, when activating the inductive heating arrangement, the susceptor arrangement 120 heats up due to eddy currents and/or hysteresis losses that are induced by the alternating magnetic field, depending on the magnetic and electric properties of the susceptor materials of the susceptor arrangement 120. The susceptor arrangement 120 is heated until reaching an operating temperature sufficient to vaporize the aerosol-forming substrate 130 surrounding the susceptor arrangement 120 within the article 100. Within a distal portion 13, the aerosol-generating device 10 further comprises a DC power supply 40 and a controller 50 (only schematically illustrated in FIG. 2) for powering and controlling the heating process. Apart from the induction coil 30, the inductive heating arrangement preferably is at least partially integral part of the controller 50.

FIG. 3 shows a detailed view (not to scale) of the susceptor arrangement 120 used within the aerosol-generating article shown in FIG. 1. According to the invention, the susceptor arrangement 120 is a multi-layer susceptor arrangement 120 comprising at least a first layer 121 and a second layer 122. In the present invention, the multi-layer susceptor arrangement 120 comprises two layers only, that is, the first layer 121 and the second layer 122 only. While the first layer 121 comprises a first susceptor material being optimized with regard to heat loss and thus heating efficiency, the second layer 122 comprises a second susceptor material which serves as temperature marker. For this, the second susceptor material is ferromagnetic and chosen such as to have a Curie temperature corresponding to a predefined temperature point for heating the substrate 130. At its Curie temperature, the magnetic permeability of the second susceptor material drops to unity leading to a change of its magnetic properties from ferromagnetic to paramagnetic. The change of the magnetic properties is accompanied by a temporary change of the electrical resistance of the susceptor arrangement 120. Thus, by monitoring a corresponding change of the electrical current absorbed by the inductive heating arrangement of the device 10, it can be detected when the second susceptor material has reached its Curie temperature and, thus, when the predefined temperature point has been reached. As such, the first layer is primarily used for heating the substrate, whereas the second layer may be considered to be a functional layer.

In the present embodiment, the first layer 121 comprises a 400 series stainless steel such as grade 410 stainless steel, or grade 420 stainless steel, or grade 430 stainless steel, or stainless steel of similar grades. Using a stainless steel proves advantageous with regard to the aging characteristics of the first layer 121 being in direct contact with the aerosol-forming substrate 130 in the substrate element 110.

As can be further seen in FIG. 3, the multi-layer susceptor arrangement 120 is in the form of an elongate strip, in which the second layer 122 is intimately coupled to the first layer 121 on top of it. The strip-shaped susceptor arrangement has a length L of 10 to 12 millimeter and a width W of 4 to 5 millimeter. That is, both layers have a length L of 10 to 12 millimeter and a width W of 4 to 5 millimeter, yet different layer thicknesses. While the first layer 121 has a layer thickness of 50 micrometer, the second layer 122 has a layer thickness of 10 micrometer. Hence, the total thickness T of the susceptor arrangement 120 is 60 micrometer. The susceptor arrangement 120 is formed by cladding the second susceptor material of the second layer 122 to the first susceptor material of the first layer 121.

However, the fact that the first and second layer are intimately coupled to each other while typically having different coefficients of thermal expansion may cause undesired internal stress. As described above, this internal stress would cause a modification of the magnetic properties of the susceptor arrangement, if the second susceptor material exhibited magnetostriction. In order to reduce these undesired effects, the susceptor arrangement according to the present invention comprises a second susceptor material which exhibits only weak or even no magnetostriction. According to the invention it has been found that this is given for an Ni—Fe-alloy having 75 wt %-85 wt % Ni and 10 wt %-25 wt % Fe. The remainder of the alloy may comprise one or more of the following elements: Co, Cr, Cu, Mn, Mo, Nb, Si, Ti and V.

In the present embodiment, the second layer 122 consists of a Ni—Fe-alloy (as second susceptor material) comprising 79 wt %-82 wt % Ni, 4 wt %-6 wt % Mo, less than 1 wt % of Si an Mn combined together, and 13 wt %-15 wt % Fe.

Alternatively, the Ni—Fe-alloy may comprise 77 wt % Ni, 16 wt % Fe, 5 wt % Cu, and 2 wt % of one of Cr and Mo. According to yet another alternative, the Ni—Fe-alloy may comprise 77 wt % Ni, 14 to 15 wt % Fe, 4 wt % Cu, and 4 wt % of Mo.

FIG. 4 shows (not to scale) details of a multi-layer susceptor arrangement 220 according another embodiment of the present invention. In contrast to the susceptor arrangement 120 according to FIG. 1-3, the multi-layer susceptor arrangement 220 according to FIG. 4 comprise a third layer 223 in addition to the first layer 221 and the second layer 222. The third layer 223 is intimately coupled to the second layer 222 (on top of it), while the second layer 222 is intimately coupled to the first layer 221 (on top of it). The third layer 223 is a protective layer consisting of an anti-corrosive material in order to protect the non-corrosion resistant second layer from any corrosive influences. This is particularly important since the susceptor arrangement 220 typically is in direct physical contact with aerosol-forming substrate as shown in FIG. 1. In addition, the third layer 223 avoids material diffusion, for example metal diffusion, from the second susceptor material into the aerosol-forming substrate. Furthermore, the third layer 223 helps to avoid or reduce thermal bending due to differences in thermal dilatation between the layers 221, 222, 223.

The susceptor arrangement 220 may be formed by first cladding the second susceptor material to the material of the first layer 221. After that, the material of the third layer 223 may be cladded on top of the second layer 222.

Preferably, the third layer 223 comprises or consists of the same material as the first layer 221. Due to this, the multi-layer susceptor arrangement 220 comprises at least two layers 221, 223 having the same coefficient of thermal expansion which results in reduced deformations of the susceptor arrangement 220 through its temperature range of operation. Accordingly, both the first layer 221 and the third layer 223 of the susceptor arrangement 220 shown in FIG. 4 may comprise a 400 series stainless steel such as grade 410 stainless steel, or grade 420 stainless steel, or grade 430 stainless steel, or stainless steel of similar grades.

Alternatively, the third layer 223 may comprise or consist of an austenitic stainless steel. As an example, the third layer 223 may comprise or consist of X5CrNi18-10 or X2CrNiMo17-12-2 (according to EN (European Standards) nomenclature). In particular, the third layer 223 may comprise or consist of one of 301 stainless steel, 304 stainless steel, 304L stainless steel, 316 stainless steel or 316L stainless steel (nomenclature according to SAE steel grades [Society of Automotive Engineers]). Advantageously, due to its paramagnetic characteristics and high electrical resistance, austenitic stainless steel only weakly shields the second susceptor material of the second layer 222 from the magnetic field to be applied thereto.

Like in FIG. 3, the second layer 222 according to FIG. 4 may consist of a Ni—Fe-alloy (as second susceptor material) comprising 79 wt %-82 wt % Ni, 4 wt %-6 wt % Mo, less than 1 wt % of Si an Mn combined together, and 13 wt %-15 wt % Fe. Alternatively, the Ni—Fe-alloy may comprise 77 wt % Ni, 16 wt % Fe, 5 wt % Cu, and 2 wt % of one of Cr and Mo. According to yet another alternative, the Ni—Fe-alloy may comprise 77 wt % Ni, 14 to 15 wt % Fe, 4 wt % Cu, and 4 wt % of Mo.

The layer thickness of the third layer 223 may be 3 micrometer to 5 micrometer, for example 3.5 micrometer. The layer thickness of the second layer 222 may be 15 micrometer to 16 micrometer. The layer thickness of the first layer 221 may be 40 micrometer 42 micrometer, in particular 40.5 micrometer to 41.5 micrometer. In total, the multi-layer susceptor arrangement 220 according FIG. 4 may have a thickness of 60 micrometer.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±5% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-25. (canceled)

26. A multi-layer susceptor arrangement for inductively heating an aerosol-forming substrate, the multi-layer susceptor arrangement comprising:
a first layer comprising a first susceptor material; and
a second layer comprising a second susceptor material, wherein the second susceptor material comprises a Ni—Fe-alloy comprising one of:
79 wt %-82 wt % Ni and 13 wt %-15 wt % Fe, or
79 wt %-82 wt % Ni, 4 wt %-6 wt % Mo, less than 1 wt % of Si and Mn combined together, and 13 wt %-15 wt % Fe, or
77 wt % Ni, 16 wt % Fe, 5 wt % Cu, and 2 wt % of one of Cr and Mo, or
77 wt % Ni, 14 to 15 wt % Fe, 4 wt % Cu, and 4 wt % of Mo.

27. The multi-layer susceptor arrangement according to claim 26, wherein the first susceptor material comprises a metal.

28. The multi-layer susceptor arrangement according to claim 26, wherein the second layer is intimately coupled to the first layer.

29. The multi-layer susceptor arrangement according to claim 26,
wherein the first layer has a layer thickness in a range between 20 micrometers and 60 micrometers, and
wherein the second layer has a layer thickness in a range between 4 micrometers and 20 micrometers.

30. The multi-layer susceptor arrangement according to claim 26,
further comprising a third layer intimately coupled to the second layer,
wherein the third layer comprises an anti-corrosive material.

31. The multi-layer susceptor arrangement according to claim 30, wherein the third layer comprises a material identical to the first susceptor material of the first layer.

32. The multi-layer susceptor arrangement according to claim 30, wherein the third layer comprises an austenitic stainless steel.

33. The multi-layer susceptor arrangement according to claim 30, wherein the third layer has a layer thickness in range between 2 micrometers and 6 micrometers.

34. The multi-layer susceptor arrangement according to claim 30, wherein the first layer, the second layer, and the third layer are adjacent layers of the multi-layer susceptor arrangement.

35. An inductively heatable aerosol-generating article comprising an aerosol-forming substrate and a multi-layer susceptor arrangement according to claim 26.

36. A multi-layer susceptor arrangement for inductively heating an aerosol-forming substrate, the susceptor arrangement comprising:
a first layer comprising a first susceptor material;
a second layer intimately coupled to the first layer and comprising a second susceptor material, the second susceptor material comprising an Ni—Fe-alloy comprising 75 wt %-85 wt % Ni and 10 wt %-25 wt % Fe; and
a third layer intimately coupled to the second layer,
wherein the first layer has a layer thickness in a range between 20 micrometers and 60 micrometers and the third layer has a layer thickness in a range between 2 micrometers and 6 micrometers.

37. The multi-layer susceptor arrangement according to claim 36, wherein the Ni—Fe-alloy further comprises one or more of the following elements: Co, Cr, Cu, Mn, Mo, Nb, Si, Ti, and V.

38. The multi-layer susceptor arrangement according to claim 36,
wherein the Ni—Fe-alloy further comprises 79 wt %-82 wt % Ni and 13 wt %-15 wt % Fe, or
wherein the Ni—Fe-alloy further comprises 77 wt % Ni, 16 wt % Fe, 5 wt % Cu, and 2 wt % of one of Cr and Mo, or
wherein the Ni—Fe-alloy further comprises 77 wt % Ni, 14 to 15 wt % Fe, 4 wt % Cu, and 4 wt % of Mo.

39. The multi-layer susceptor arrangement according to claim 36, wherein the first susceptor material comprises a metal.

40. The multi-layer susceptor arrangement according to claim 36,
wherein the first layer has a layer thickness in a range between 30 micrometers and 50 micrometers.

41. The multi-layer susceptor arrangement according to claim 36, wherein the second layer has a layer thickness in range between 4 micrometers and 20 micrometers.

42. The multi-layer susceptor arrangement according to claim 36,
wherein the third layer comprises an anti-corrosive material, or
wherein the third layer comprises a material identical to the first susceptor material of the first layer, or
wherein the third layer comprises an austenitic stainless steel.

43. The multi-layer susceptor arrangement according to claim 36, wherein the third layer has a layer thickness in a range between 3 micrometers and 5 micrometers.

44. The multi-layer susceptor arrangement according to claim 36, wherein the first layer, the second layer, and the third layer are adjacent layers of the multi-layer susceptor arrangement.

45. An inductively heatable aerosol-generating article comprising an aerosol-forming substrate and a multi-layer susceptor arrangement according to claim 36.
